(19) United States
(12) Patent Application Publication
(10) Pub. No.: US 2004/0203926 A1
(43) Pub. Date: Oct. 14, 2004

(54) Selection of measurement apparatus for location of user equipment

(76) Inventors: Ville Ruutu, Espoo (FI); Jarko Niemenmaa, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/823,792

(22) Filed: Apr. 14, 2004

Related U.S. Application Data
(60) Provisional application No. 60/462,310, filed on Apr. 14, 2003.

(51) Int. Cl. H04Q 7/20

(52) U.S. Cl. 455/456.1; 455/414.1; 455/456.5

(57) ABSTRACT

A location system for locating a mobile user equipment comprises at least two measurement devices configured to provide measurement data for location determination. A quality controller is provided, the controller being configured to provide quality information of measurements by the at least two measurement devices. Quality information of measurements by the at least two measurement devices is stored in a storage. A selection controller provides selection information for selection of measurement devices based upon quality information stored in the storage.

### REFERENCE TO RELATED APPLICATIONS

This application claims priority of U.S. Provisional Patent Application Serial No. 60/462,310, filed on Apr. 14, 2003, the contents of which are hereby incorporated by reference.

### BACKGROUND OF THE INVENTION

1. Field of the Invention

The present disclosure relates to location apparatus for a mobile communication system, and in particular, but not exclusively, to selection of measurement apparatus for locating a mobile user equipment.

2. Description of the Related Art

A communication system can be seen as a facility that enables communication sessions between two or more entities such as user equipment and/or other nodes associated with the communication system. The communication may comprise, for example, communication of voice, data, multimedia and so on. A user equipment connected to a communication system may, for example, be provided with a two-way telephone call or multi-way conference call. A user equipment may also communicate via the communication system with an application providing entity, for example to an application server (AS), thus enabling use of services provided by means of the application server.

Communication systems proving wireless communication for user equipment are known. These systems are commonly referred to as mobile systems. An example of the mobile systems is the public land mobile network (PLMN). A PLMN is commonly based on cellular architecture. Another example is a mobile system that is based, at least partially, on use of communication satellites. Mobile communications may also be provided by means of other mobile systems, such as by means of wireless local area networks (WLAN).

Communication on the wireless interface between the user equipment and the elements of the mobile system can be based on an appropriate communication protocol. The operation of the station apparatus of the communication system and other apparatus required for the communication can be controlled by one or several control entities. The various control entities may be interconnected. One or more gateway nodes may also be provided for connecting a communication network to other networks. For example, a mobile network may be connected to communication networks such as an IP (Internet Protocol) and/or other packet switched data networks.

In a typical mobile system a base transceiver station (BTS) serves mobile stations (MS) or similar mobile user equipment (UE) via an air or radio interface. A base station provides a radio access entity that is typically but not exclusively referred to as a cell. The approximate location, size and shape of the cells of a system is known, each of the cells covering a particular geographical area. Several cells may also be grouped together to form a larger service area. A geographical area may be served by more than one base stations. A mobile station may also be in communication with two or more base stations at the same time. The two or more base stations may be connected to the same controller or different controllers.

The mobile system can also be arranged to provide location information concerning a mobile station and thus the user thereof. More particularly, the geographically limited radio access entities of a mobile system facilitate production of at least a rough location information estimate concerning the geographical location of a mobile station, as the mobile system is aware of the cell or similar access entity with which a mobile station currently associates. Therefore it is possible to conclude from the location of the cell the geographical area in which the mobile station is likely to be at a given moment. This information is available also when the mobile station is located within the coverage area of a visited or “foreign” network. The visited network may be capable of transmitting location information of the mobile station back to the home network, for example to support location services or for the purposes of call routing and charging.

The management of location information may be provided by a separate network element, for example a location service (LCS) entity such as a location service server adapted to receive information from location determination entities connected to the mobile system. A LCS service entity may be employed in the provisioning of location information associated with a target user equipment for entities who have requested for such information. Such entities will be called hereinafter the clients. A LCS client may make use of that location information for various services/applications. The location service entity may implemented within the cellular system or connected thereto. The location service entity provided by the communication system may serve different clients via an appropriate interface.

Cell level location may be determined based upon information of the current cell identity (CI). If no further computations and/or approximations are made, this would give the location to an accuracy of one cell, i.e. it would indicate that the mobile station is, or at least was, within the coverage area of a certain cell. However, more accurate information concerning the geographical location of a mobile station may be desired. For example, the United States Federal Communication Commission (FCC) has mandated that wireless service providers have to implement location technologies that can locate wireless phone users who are calling to E911 emergency centre. The FCC has also defined certain accuracy requirements for the location.

Although the FCC order is directed to emergency caller location, more accurate location information might be found useful by other use applications, both commercial and non-commercial. For example, usability of applications such as fleet management, location-dependent billing, navigation, various advertisement schemes and so on might be improved by improving the accuracy of the location. More detailed examples of possible applications include different local advertisement and information distribution schemes, for example transmission of information directed to those mobile users only who are currently within a certain area, area related WWW-pages such as time tables, local restaurant, shop or hotel guides, maps local advertisements and so on for the users of mobile devices, and tracking of mobile users by anyone who is legally entitled to receive location information. It should be appreciated that the above are only examples and there are several other possible commercial and non-commercial applications which may use the location information provided by a location service (LCS) provided in association with a mobile system.

Information for improving the accuracy of location determinations a mobile system may be provided by means of specific location determination entities that provide more accurate data or additional data concerning the location of a mobile user equipment. In this disclosure such entities will be referred to hereinafter as location measurement units (LMUs). A location measurement unit may be positioned either independently from a base station site or co-site with a base station.

More accurate location information may be obtained, for example, by calculating the geographical location from range measurements or range difference (RD) measurements. Another possibility to improve the accuracy is to employ the known satellite based GPS (Global Positioning System) when providing location information. More accurate location information can be obtained through a differential or assisted GPS.

In the range or range difference techniques, the reliability of the location determination is improved by utilizing results of measurements which define the travel time or travel time differences of radio signals sent by a mobile station to one or more base stations, or by at least one base station to a mobile station. The measurements may be accomplished at a number of location measurement units which are usually provided at base station sites covering the area in which the mobile station is currently located. The measurement by each of the location measurement units (LMUs) gives the distance (range) between a base station the location measurement unit associates with and a mobile station or distance difference (range difference) between a mobile station and two base stations. Each of the range measurements generates a circle that is centered at the measuring base station. A mobile station can then be determined to be located at an intersection of the circles. Range difference measurements by two base stations create a hyperbola, see FIG. 1.

An example of these methods is the Uplink Time Difference Of Arrival (U-TDOA) location method, which has been proposed to be included in GSM (Global System for Mobile) Standards Release 6. For example, in the United States GSM operators have selected U-TDOA as a method for satisfying E911 emergency call location requirements mandated by the Federal Communications Commission (FCC). The principle of this exemplifying range difference location method is described hereinafter with reference to FIG. 1.

In the Uplink Time Difference Of Arrival (U-TDOA) location method the location measurement units (LMU) measure usual transmissions from a mobile station (MS) to be located. Difference between Time Of Arrival (TOA) values of signals sent by the mobile station are measured by LMUs 1 and 2 in two different positions. This Time Difference Of Arrival (TDOA) value, equal to TOA₁-TOA₂, determines a hyperbola:

c*(TOA₁−TOA₂)=dₘ₁₋dₘ₂,

where

c is the speed of radio waves, and

dₘ₁ and dm₂ denote the distance from the MS to LMUs 1 and 2, respectively.

When at least two hyperbolas have been obtained, it is possible to determine the estimate of the position of the mobile station at the intersection of hyperbolas. In some cases two hyperbolas can have two intersections. Then a unique solution requires one additional hyperbola, or other additional information, for example coverage area of the reference cell, is needed to select one of the intersections.

In a properly working U-TDOA system a controlling network element needs to decide which location measurement units should be used to locate a certain mobile station. Usually this controlling element is a location service entity such as the Serving Mobile Location Center (SMLC) or a separate element connected to it. These separate elements are sometimes called Position Determination Elements (PDE).

It should be appreciated that the above is only an example, and that data from other measurements may also be used in location determination.

Regardless of the technology of the application, there is no point to order a location measurement unit to try to receive the transmissions of a mobile station, if the location measurement unit cannot receive the signals, for example if the location measurement unit too far away or blocked. On the other hand, for best possible location accuracy it should be ensured that all location measurement units that can receive signals from the mobile station with reasonable quality are ordered to do so.

There are also capacity concerns. If U-TDOA LMUs are implemented as one channel receivers, that is, the LMUs can only measure transmissions from one mobile station at the time, measurement capacity should not be wasted by ordering a LMU to measure a mobile station that it has no possibilities to receive signals from the mobile station.

A solution could be to use the identity of the cell serving the mobile station to estimate which LMUs could potentially be able to receive the mobile transmissions. Still, the cell sizes in GSM and other cellular systems can be large, and thus unnecessary LMUs might be included in the measurements. Also, it is not always easy to estimate radio propagation conditions. For example, if a mobile station to be located happens to be in a concrete building, even a close-by LMU might not be able to receive it, especially if the LMU is situated on the other side of the building. A mobile station may become blocked from a close-by LMU also for various other reasons.

Therefore there is a need to improve the selection of suitable location measurement units.

### SUMMARY OF THE INVENTION

Embodiments of the present invention aim to address one or several of the above problems.

According to one embodiment, there is provided a method of providing information associated with location determination apparatus of a mobile system. In the method quality information of measurements associated with location determination is provided by at least two measurement devices. Quality information of measurements associated with location determination by at least two measurement devices and identity information associated with the at least two measurement devices is stored in a storage. Selection information is provided for selection of measurement devices based upon the stored quality and identity information.

According to another embodiment, there is provided a method of providing location information associated with a user equipment of a mobile system. In the method a location process is triggered by an event. Selection information is then obtained for selection of at least one measurement device. The selection information includes information of measurement devices that have historically provided measurement information that satisfies a predefined criteria. At least one measurement device is then selected, and the user equipment is located based on measurement information from the selected at least one measurement device.

According to another embodiment, there is provided a location system for locating a mobile user equipment. The system comprises at least two measurement devices configured to provide measurement data for location determination, a quality controller configured to provide quality information of measurements by the at least two measurement devices, and a storage configured to store quality information of measurements by the at least two measurement devices. A selection controller is also provided, the controller being configured to provide selection information for selection of measurement devices based upon quality information that is stored in the storage.

According to yet another embodiment, there is provided a processor for processing quality information associated with the quality of location measurements by a plurality of measurement devices and for providing selection information for selection of at least one measurement device based upon the quality information. The processor may be provided in an element of a communication network, or in a user equipment.

The embodiments of the invention may provide improved location performance and capacity. If several measurement devices are available history data can be utilized to select the most probably working measurement device or a measurement device with lower load. Loading of the mobile system may be reduced. The quality of the measurements may be improved.

### BRIEF DESCRIPTION OF DRAWINGS

For better understanding of the present invention, reference will now be made by way of example to the accompanying drawings in which:

FIG. 1 shows a user equipment in communication with a plurality of location measurement units;

FIG. 2 shows a mobile system wherein the present invention may be embodied;

FIGS. 3 to 5 are flowcharts illustrating some embodiments of the present invention.

### DETAILED DESCRIPTION OF THE PREFERRED EMBODIMENTS

It is noted that even though the exemplifying mobile system shown and described in more detail in this disclosure uses the terminology of the GSM (Global System for Mobile telecommunications) public land mobile network (PLMN), embodiments of the proposed solution can be used in any mobile system, such as in the 3^{rd} generation WCDMA (Wideband Code Division Multiple Access) UMTS (Universal Mobile Telecommunications System) or CDMA2000 mobile systems, wherein measurement devices are provided for determining location of a mobile user equipment.

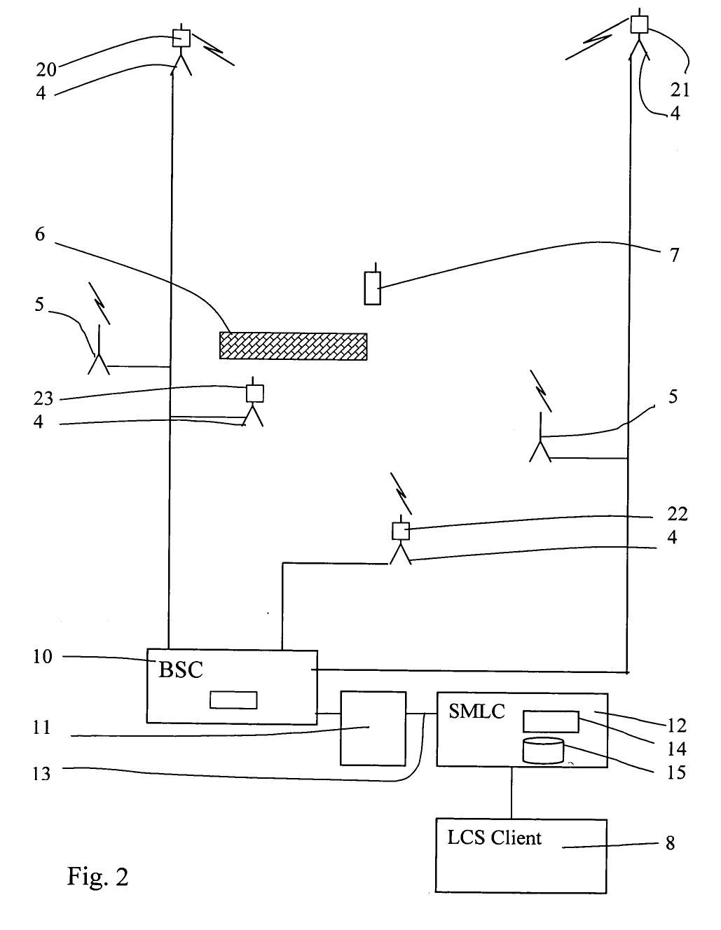

Reference will now be made to FIG. 2 in which a number of base stations 4 and 5 provide radio coverage areas or cells of a cellular communications network. Each base station (BTS) may serve one or more cells or similar access entities. The difference between base stations 4 and 5 is that each of base stations denoted with reference numeral 4 is provided with a location measurement unit (LMU).

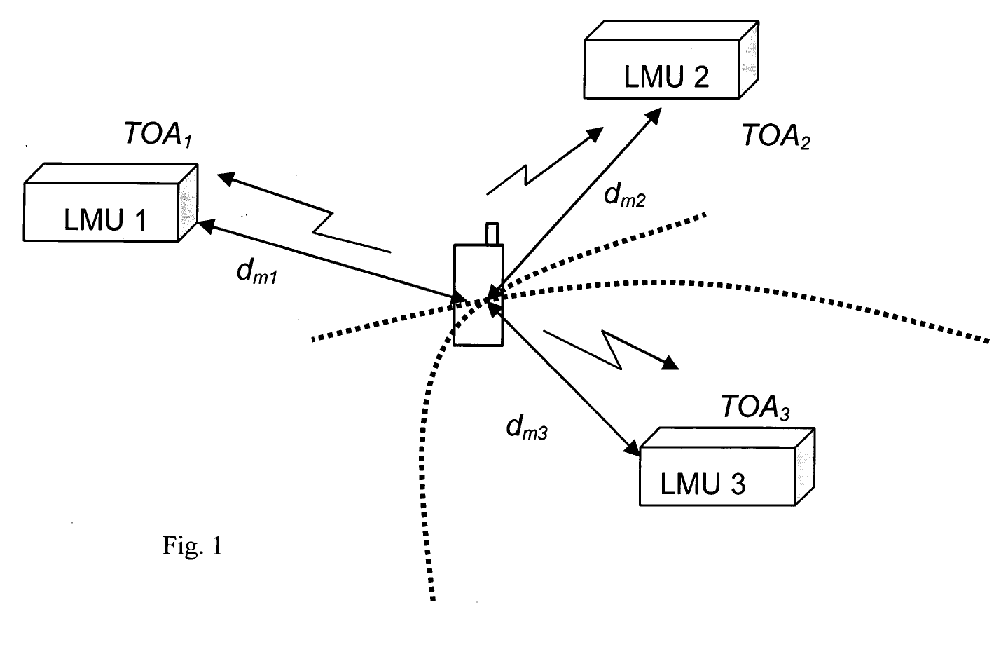

Each base station is arranged to transmit signals to and receive signals from a mobile user equipment 7, referred to hereinafter a mobile station (MS). Likewise, the mobile station 7 is able to transmit signals to and receive signals from the respective base station. The mobile station 7 accomplishes this via wireless communication with the base stations. Typically a number of mobile stations may be in communication with each base station although only one mobile station is shown in FIG. 1 for clarity. The mobile station 7 is able to move within the cell and also from one cell coverage area to another cell coverage area. The location of the mobile station 7 may thus vary in time as the mobile station is free to move within the service area of the mobile system.

The geographical location of the base stations is known. The geographical location of the base station and/or the mobile stations may defined, for example, in X and Y co-ordinates or in latitudes and longitudes. It is also possible to define the location of the base stations in vertical directions. For example, Z co-ordinate may be used when providing the location information in the vertical direction. The vertical location of the base stations may be needed, For example, in mountainous environments or in cities with tall buildings to be able to determine the location of a mobile station.

A location measurement unit (LMU) 20, 21, 22, 23 is shown to be provided in association with selected base stations 4. Base station sites that are provided with a LMU facility are referred to hereinafter as LMU sites. The location measurement unit (LMU) is adapted to a accomplish measurements so that the location of the mobile station 7 may be accurately determined based on the measurements. Some of the possible measurements by the location measurement units 20 were already discussed above.

The closest LMU 23 is shown to be blocked by wall 6 from having a line of sight communication path with the mobile station 7.

It should be appreciated that although the location measurement units of FIG. 2 are shown to be attached to the base stations 4, it is possible to dispose the LMU units in a remote location and to connect the units to the respective base station or several base stations by an appropriate communication media such as by cabling or a suitable wireless connection.

Each of the base stations is connected to a network controller 10, which in the exemplifying mobile system is a base station controller (BSC). The BSC may be a part of a radio access network which sometimes may be referred to as a base station subsystem (BSS). It should be appreciated that typically more than one controller is provided in a network. The controller 10 is commonly connected to other network elements 11, such as to a mobile switching center (MSC), a gateway node and so on via suitable interconnections.

FIG. 2 also shows a Location Services (LCS) entity 12 providing location services for different applications or clients 8. In general terms, the LCS entity can be defined as an entity capable of providing information concerning the geographical location of a mobile station based on information received from the mobile system. In FIG. 2 example the LCS entity 12 comprises a Serving Mobile Location Center (SMLC). However, it shall be appreciated that similar functionality may be provided by differently named entities, for example a Position Determination Element (PDE) or a Gateway Mobile Location Center (GMLC). The LCS entity may be provided for example by means of a controller such as server. The LCS entity 12 will therefore be called in the example below a location server.

The location server 12 of FIG. 1 is arranged to receive predefined information concerning the location of the mobile station 7 from the radio access network via an appropriate interface 13. The information received by the location server 12 may include the identity of the mobile station 7, the identity of the current cell (CI), the identity of the service area (containing one cell or several cells) that is serving the mobile station and/or measurement results by the location measurement units 20 to 23. The location server 12 may then process this information and/or some other predefined parameters and/or compute by processor means 14 appropriate calculations for determining and outputting the geographical location of the mobile station 7. The location server 12 further comprises a storage 15 for storing data.

The location server 12 may be arranged to request for location information from the PLMN and/or location information may be “pushed” from the PLMN to the server. In addition, the location server 12 may define the accuracy that is desired. The required accuracy may be indicated e.g. by so called quality of service (QoS) parameters included in a location request for location information. Such a request may originate from a LCS client 8.

The LCS client 8 is an entity that makes a request to the location 12 for the location information of one or more target mobile stations. The client 8 may be an entity that is external to the mobile system. The client 8 may also be an internal client (ILCS) i.e. reside in any entity (including a mobile station) within the mobile system. The LCS clients are entitled to receive at least some degree of information concerning the location (or location history) of the mobile station 7. The location server 12 serves the client based on information available from the mobile system. This information may be processed in a predefined manner and location information may then be provided to the client 8. The location server 12 may thus provide the client 8, on request or otherwise, the current or most recent geographic location of a target mobile station or, if the location fails, an error indication and optionally the reason for the failure.

It should be appreciated that the above elements of the location service function are given as example only, and that the structure of the location information service may be different from the above described. The location information service may be implemented anywhere in a mobile system or in association with a mobile system. The location service implementation may be distributed between several elements.

In one embodiment, the invention comprises utilization of history data to provide selection criteria to select proper location measurement units. This may provide self learning based upon historical good quality measurements.

In another embodiment, a controller element may include hardware and/or software which creates a self-learning table which matches appropriate look-up parameters with information regarding the success of measurements by a location measurement unit obtained after a location attempt. The controller may maintain statistical/history information about which location measurement units were able to receive transmissions from mobile stations when a certain look-up parameter was observed. The controller may also be provided with a neural network which is configured to automatically adapt to new location areas in the self-learning table

The embodiments described in the following relate to selection of at lest one measurement device for location determination in a mobile system. Selection of proper measurement device or devices is an important step when trying to optimize the process of providing location information. Good quality measurements satisfy various criterion, depending on the application. Obviously, one criteria is that the measurement device can receive signals from the mobile station. Other examples of good conditions from the radio point of view include a satisfactory received signal level and interference level from the measured cells and a LOS (line-of-sight) connection between the measurement device and the mobile station. A measurement device satisfying the criteria will be called below successful location measurement unit.

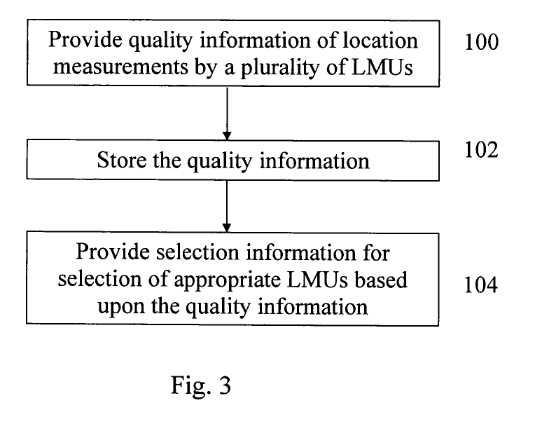

A process of providing information for supporting selection of location measurement units is illustrated by the flowchart of FIG. 3 disclosing a method of providing information associated with location determination apparatus of a mobile system. In step 100 quality information of location measurements by a plurality of location measurement units is provided. There are various possibilities to provide the quality information, few examples being described in more detail later in this disclosure. An important aspect in here is to provide such quality information which can be used later to conclude if a specific location measurement unit (LMU) can be used for providing measurement data regarding a mobile station whose location is roughly known.

The quality information is preferably provided for processing by the processor 14 of the location server 12 of FIG. 2. The quality information is then stored at step 102, preferably in a database of the location server 12. The quality information is stored such that it can be associated with the respective location measurement unit, for example based upon information identifying the location measurement unit.

Selection information for selection of appropriate location measurement units is provided at step 104. The selection information is generated based upon the quality information provided at step 100. The generation is preferably performed by the processor 14 of the location server 12.

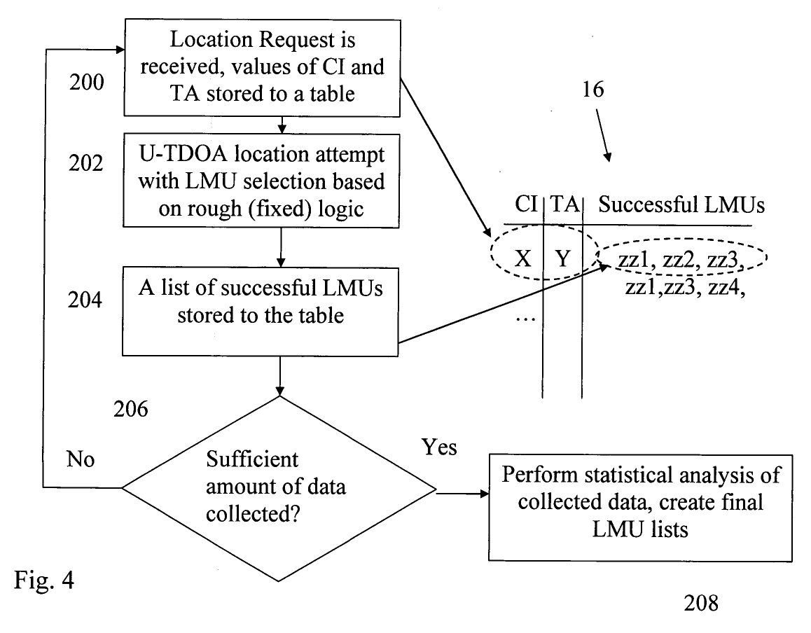

In accordance with an embodiment, the step 104 comprises self-learning based upon historical quality information of the location measurement units. An example of the self-learning mechanism is disclosed below with reference to FIG. 4. Step 104 may also comprise ranking of possible location measurement units based upon historical quality information of the location measurement units. The result of the ranking may then be presented on a list of location measurement units, preferably such that the most useful location measurement unit tops the list. Proper location measurement units may then be selected based on the ranking.

A detailed example of how to optimize system performance by means of a self-learning location measurement unit selection mechanism referred above as a possible embodiment is described below in the context of a GSM SMLC and U-TDOA based location. In the embodiment a SMLC creates a self-learning table 16 or similar where available look-up parameters before a U-TDOA location attempt, such as cell identities (CI) and timing advance (TA) values or location estimate based on them, are matched with information regarding the success of respective LMU measurements that are obtained after U-TDOA location attempts.

The general GSM standards Location Services (LCS) specifications, for example, GSM 03.71, define that a SMLC obtains the cell identity (CI) of the cell serving a mobile station (MS) when a request for location information is received. In FIG. 3 this would occur at step 200. At this stage the SMLC may also obtain a valid Timing Advance (TA) value. If the TA value is not obtained automatically, the SMLC may request it from the BSC by using any appropriate protocol and interface. The SMLC may then store the values of these parameters in appropriate locations in the table 16.

Other information may also be provided at this stage. For example, in certain implementations it is possible to have information about radio interface such as the Received Signal Strength (RX) levels as measured by the mobile station. The SMLC may then calculate a rough location estimate using these parameters before trying any advanced location method, such as the U-TDOA.

The selection criteria for LMUs to be used at step 202 can be rather loose. This may be preferred since in this stage it is possible that quite a number of LMUs is still involved. However, once a sufficient amount of statistical/history data has been collected, the SMLC can start at step 204 to use the data to estimate which LMUs are most likely to perform useful measurements. The sufficient amount of data may be collected after certain learning period, or the collection may occur gradually. If at least one successful LMU is found, information thereof is stored in the table such that the LMU associates with the respective CI, TA or other parameters.

If it is concluded at step 206 that sufficient amount of data is collected, the selection information generation process is passed to step 208 wherein a statistical analysis of the collected data is performed, and LMU lists are generated. If more data is needed, the process is returned to step 200.

In other words, the location server may maintain statistical/history information about which LMUs were able to receive transmissions from a mobile station when certain CI and TA or location estimate based on them were observed. In the above embodiment an Uplink Time Difference Of Arrival (UTDOA) location measurement unit (LMU) is configured to be self learning based on history data (analysis) which can be used as a selection criteria when selecting proper location measurement units which have provided good quality measurements historically.

In accordance with a further embodiment the self-learning process employs a neural network which can automatically adapt to new cells in the self-learning table.

A neural network such as a neuro network or a neuro-fuzzy network may be provided by means of a software that can be trained to classify the latest history data into information signal states based on combining signal levels and trends. The skilled person is familiar with the principles of neural networks. A neural network outputs can be ranked after membership grade to indicate the most likely result. The input to a neural network may contain a fixed number of sampling points of the history up to current time. The output of a neural network may contain signal states that have been obtained as a combination of different signal levels.

A neuro-fuzzy network typically consists of fuzzified inputs and/or outputs. The fuzzification for each variable expresses the membership grade of the variable in a certain class of conditions. Due to the overlap between fuzzy sets (membership functions) the network provides a natural framework for treating transition phenomena between different conditions and reasoning under uncertainties.

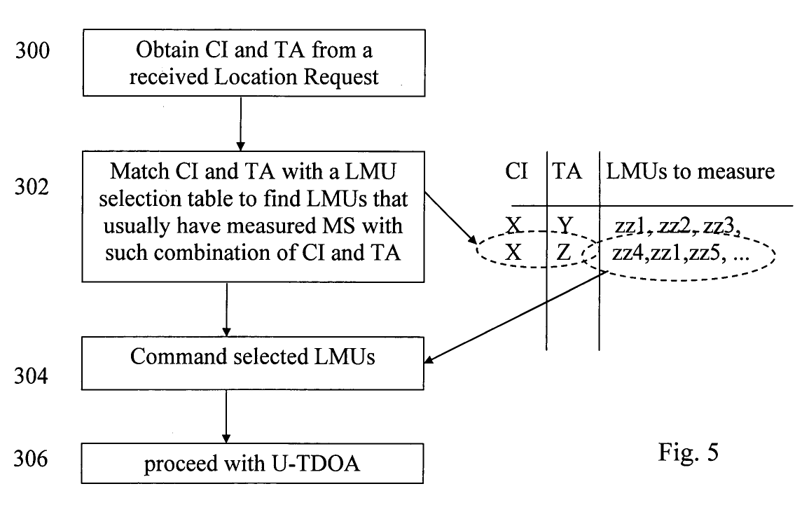

FIG. 5 shows an example of a possible use of the table 16 created in FIG. 4. The SMLC obtains at step 300 CI and TA parameters for example in a request for location estimate from a client. The SMLC checks at step 302 from the self-learning table 16 which location measurement units have been normally able to receive the mobile station with this particular combination of CI and TA. Information regarding suitable location measurement units is obtained at step 304 from the table. The SMLC may then use at least some of these at step 306 for a U-TDOA location attempt.

The SMLC might also use a rough location estimate based on CI and TA as such, or in combination with actual CI and TA values for finding the appropriate location measurement units from the table at step 302. Also in some implementations RX levels or other radio interface information might be useful.

If there are changes in the mobile system, such as change in CI parameters, the learning period of FIG. 4 might need to be repeated, and meanwhile fall-back to cruder location measurement unit selection approaches is needed. A neural network solution may also be used when addressing changes in the mobile system.

The above data processing functions may be provided by means of one or more data processor entities. Appropriately adapted computer program code product may be used for implementing the embodiments, when loaded to a computer, for example for performing the computations and the searching, matching and combining operations. The program code product may be stored on and provided by means of a carrier medium such as a carrier disc, card or tape. A possibility is to download the program code product via a data network. Implementation may be provided with appropriate software in a location server. Thus it may be that no additional hardware is needed is some applications. Additional memory and processing capacity may be needed in a location server.

It should be appreciated that whilst embodiments of the present invention have been described in relation to mobile stations, embodiments of the present invention are applicable to any other suitable type of user equipment.

In the above the exemplifying controller element that decides which Location Measurement Units should be used to locate a certain mobile station is provided in a Serving Mobile Location Center (SMLC) or a separate element connected to it, for example a Position Determination Element (PDE). However, any control element configurable to perform the analysis may be used or this function. A suitable controller preferably includes hardware and/or software necessary for analyzing historical information and for deciding which location measurement units should be used to locate a particular mobile station.

The controller may also be provided in a user equipment. The user equipment comprises a processor for processing quality information associated with the quality of location measurements by a plurality of measurement devices and for providing selection information for selection of at least one measurement device based upon the quality information. In accordance with a possible embodiment the user equipment is provided with a selector capable of selecting appropriate measurement devices based on information received from the network.

Collected self-learning information might be useful for other purposes as well, such as network planning, or network performance monitoring.

It is understood that other embodiments of the invention are possible, while remaining within the scope of the invention. Thus the invention is also applicable to any other mobile techniques than the GSM, including any 2nd generation or 3^{rd} generation mobile system, and any hybrids thereof.

It is also noted herein that while the above describes exemplifying embodiments of the invention, there are several variations and modifications which may be made to the disclosed solution without departing from the scope of the present invention as defined in the appended claims.

1. A method of providing information associated with location determination apparatus of a mobile system, said method comprising:
providing quality information of measurements associated with location determination by at least two measurement devices;
storing quality information of measurements associated with location determination by at least two measurement devices and identity information associated with the at least two measurement devices; and
providing selection information for selection of measurement devices based upon the stored quality and identity information.

2. The method of claim 1, wherein the step of providing selection information comprises self-learning based upon historical quality information associated with measurement devices.

3. The method of claim 1, wherein the step of providing selection information comprises ranking possible measurement devices based upon historical quality information associated with measurement devices.

4. The method of claim 3, comprising the further step of selecting proper measurement devices based on the ranking.

5. The method of claim 1, comprising storing information identifying at least one cell of a mobile system.

6. A method of providing location information associated with a user equipment of a mobile system, said method comprising:
triggering a location process;
obtaining selection information for selection of at least one measurement device, the selection information including information of measurement devices that have historically provided measurement information that satisfies a predefined criteria;
selecting at least one measurement device; and
locating the user equipment based on measurement information from the selected at least one measurement device.

7. A method of determining a position of a mobile user equipment, said method comprising:
storing historical data of various measurements in a mobile system;
selecting at least one measurement device based upon the historical data;
self-learning based upon selected historical data associated with measurement devices.

8. The method of determining a position of a mobile user equipment as claimed in claim 7, wherein the step of self-learning comprises maintaining a self-learning table wherein look-up parameters are matched with information regarding the success of measurements by measurement devices obtained after a location attempt.

9. The method of determining a position of a mobile user equipment as claimed in claim 8, wherein the step of maintaining creation a self-learning table comprises maintaining statistical historical information about which measurement devices were able to receive transmissions from the mobile user equipment when at least one look-up parameter was observed.

10. The method of claim 8, comprising matching cell identity and timing advance parameters and/or a location estimate with information regarding the success of measurements by measurement devices obtained after a location attempt.

11. The method of claim 8, comprising matching look-up parameters with information regarding the success of measurements by location measurement units obtained after an uplink time difference of arrival location attempt.

12. A location system for locating a mobile user equipment, comprising:
at least two measurement devices configured to provide measurement data for location determination;
a quality controller configured to provide quality information of measurements by the at least two measurement devices;
a storage configured to store quality information of measurements by the at least two measurement devices; and
a selection controller configured to provide selection information for selection of measurement devices based upon quality information that is stored in the storage.

13. The location system of claim 12, wherein the quality controller, the storage and the selection controller are provided in a location service element of a mobile system.

14. The location system of claim 12, comprising a location service element configured to select at least one measurement device based upon selection information, the selection information including information of measurement devices that have historically provided measurement information that satisfies a predefined criteria, and to locate a user equipment based on measurement information from selected at least one measurement device.

15. The location system of claim 12, wherein the selection controller is provided in a user equipment.

16. A network element for a mobile system comprising a processor for processing quality information associated with the quality of location measurements by a plurality of measurement devices and for providing selection information for selection of at least one measurement device based upon the quality information.

17. The network element of claim 16, wherein the processor is configured to provide deciding means for deciding which location measurement units can be used to locate a particular mobile user equipment.

18. The network element of claim 16, comprising a serving mobile location center.

19. The network element of claim 16, comprising a separate network element connected to a serving mobile location center.

20. A user equipment for a mobile system, the user equipment comprising a processor for processing quality information associated with the quality of location measurements by a plurality of measurement devices and for providing selection information for selection of at least one measurement device based upon the quality information.

21. A computer program comprising program code means adapted to perform at least one of steps of providing quality information of location measurements by a plurality of measurement devices and selection information for selection of measurement devices based upon the quality information when the program is run on a computer.
